(19) United States
(12) Patent Application Publication
(10) Pub. No.: US 2023/0383085 A1
(43) Pub. Date: Nov. 30, 2023

(54) POLYLACTIC ACID-BASED BEAD FOAM ARTICLES HAVING ULTRA-HIGHLY PLANAR PARTICLES

(71) Applicant: Lifoam Industries, LLC, Greer, SC (US)

(72) Inventors: Saumitra Bhargava, Clarksville, MD (US); Jonathan Godfrey, Joppa, MD (US)

(21) Appl. No.: 18/303,209

(22) Filed: Apr. 19, 2023

Related U.S. Application Data
(60) Provisional application No. 63/363,213, filed on Apr. 19, 2022.

(51) Int. Cl. C08J 9/232; C08J 9/00

(52) U.S. Cl. CPC C08J 9/232; C08J 9/009; C08J 2367/04

(57) ABSTRACT

Molded foam articles are provided. The molded foam articles are formed from polylactic acid and include a plurality of ultra-highly planar particles. Forming the molded foam articles from polylactic acid with ultra-highly planar particles advantageously reduces molding time and manufacturing costs, and improves both mechanical and thermal properties.

### CROSS-REFERENCE TO RELATED APPLICATION

This application claims priority to U.S. Provisional Patent Application No. 63/363,213, filed Apr. 19, 2022, which is incorporated herein by reference.

### FIELD OF THE DISCLOSURE

This disclosure relates generally to foam articles and, in particular, relates to enhanced foam articles formed from polylactic acid and ultra-highly planar particles.

### BACKGROUND

Foam articles are used in a variety of diverse industries including thermal insulation and protective packaging, construction, infrastructure support, foodservice, and consumer products such as surfboards. Foam articles are commonly produced from expandable polystyrene (EPS), which has a well-known manufacturing process, and may take the form of molded foam articles, sheet foam articles, foam film articles, or injection molded articles. However, EPS-based foam articles suffer from a variety of drawbacks including the generation of waste due to poor recyclability, the presence of volatile organic blowing agents demonstrated to have detrimental climate effects, and limited compression cycles.

Prior attempts to reduce foam article waste have included a shift towards biobased and compostable foam materials as alternatives to EPS. For example, polylactic acid (PLA) can be used to produce foam articles having insulative and protective properties equal to or superior to those of EPS, but with the added benefit of being compostable. However, there remains a need to reduce cost, increase yield, and improve the properties of molded bead foam articles, including those formed from PLA.

Accordingly, improved foam articles are needed for overcoming one or more of the technical challenges described above.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a graph of compression set versus deflection distance in accordance with the present disclosure.

### DETAILED DESCRIPTION

Foam articles are provided herein including foam articles formed from expandable polylactic acid (PLA or ePLA) and ultra-highly planar particles. In particular, it has been unexpectedly discovered that forming the foam article from polylactic acid and including ultra-highly planar particles enhances resistance to thermal energy transfer, enhances mechanical properties, decreases production time, reduces variability in mechanical properties and increases viscosity and tenacity.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions refers to the dimension plus or minus 10%.

### Foam Articles

Foam articles are disclosed herein. In some embodiments, the foam articles comprise polylactic acid (PLA). As used here, a “foam article” refers to an article formed from a polymeric foam and may refer to molded bead foam articles, sheet foam articles, foam film articles, or injection molded foam articles. For example, molded bead foam articles are articles that have gone through an expansion and bead molding process. The article may be in the form of a two-dimensional panel or a three-dimensional structure such as a box.

In some embodiments, the foam article includes a plurality of ultra-highly planar particles to form a percolation network. As used herein, “percolation” refers to the formation of clusters of particles, and “ultra-highly planar particles” refers to exfoliating particles that are planar with a very high aspect ratio, i.e., both the length and width of a given particle are 50-1000 times greater than thickness. These particles are capable of forming into clusters when included in the polymer melt. Without intending to be bound by any particular theory, it is believed that ultra-highly planar particles have particle-to-particle interconnectivity that contributes to their tendency to accumulate, and that by including these ultra-highly planar particles in the PLA polymer melt, the PLA polymer melt may be extruded into foam beads having an internal structure which leads to higher tenacity foam articles. Without intending to be bound by any particular theory, it is believed that the ultra-highly planar particles contribute to superior bead foam particle fusion, leading to increased tenacity. It is further believed that the ultra-highly planar particles influence polymeric chain movement, contributing to at least one of bead wall thinness, fewer collapsed cells near the bead wall, finer cell structure within the bead, or the like. It has been unexpectedly discovered that the inclusion of ultra-highly planar particles in the PLA polymer melt enables foam bead formation without other additives.

In some embodiments, the ultra-highly planar particles are present in an amount of between about 0.25% to about 5% by weight of the PLA composition. In some embodiments, ultra-highly planar particles present in an amount of between about 0.25% to about 0.8% results in significant improvements in the thermal and mechanical properties of the foam article. It has been unexpectedly discovered that the inclusion of ultra-highly planar particles at concentrations even as low as 0.25% results in these improvements.

In some embodiments, the PLA may be high viscosity PLA. In other embodiments, the PLA may include a chain extender. In some embodiments, the composition may include blends of PLA with polybutylene succinate, poly(butyl adipate), polyhydroxy alkanoate, or starch. In some embodiments, the PLA may be copolymerized with other biopolyesters.

In some embodiments, the ultra-highly planar particles comprise graphite, mica, quartz, high structure carbon, carbon nanotubes, montmorillonite, fumed silica, wollastonite, kaolin or a combination thereof. In some embodiments, the ultra-highly planar particles include a surface treatment to enhance compatibility with PLA. In some embodiments, the ultra-highly planar particles include natural or synthetic graphite. In some embodiments, the ultra-highly planar particles include expandable graphite. Without intending to be bound by any particular theory, it is believed that expandable graphite may exfoliate into thin layers, enabling the molded foam article to reach the percolation threshold with a smaller graphite loading than natural or synthetic graphite. In some embodiments, the ultra-highly planar particles include nanosized graphite.

In some embodiments, the ultra-highly planar particles have size of between about 0.5 microns to about 300 microns, such as between about 8 microns to about 60 microns. The “size” of the ultra-highly planar particles is measured either when the particles are produced and sorted by a sieving process, and/or through laser diffraction. This sieving process inevitably permits particles of varying sizes through the sieve, so the “size” of the ultra-highly planar particles refers to an average size of 90-95% of the particles. Without intending to be bound by any particular theory, it is believed that larger particle sizes will have greater influence on the foam cell size and/or structure. However, it is believed that the ultra-highly planar particles will break into smaller particles due to shear forces as the foam particles are formed into the foam article.

In some embodiments in which the foam article is a molded bead foam article, after repeated compression cycles each at 10% compression, the molded bead foam article loses less than 4% of its deflection strength. In some embodiments, after repeated compression cycles each at 20% compression, the molded foam article loses less than 10% of its deflection strength. As used herein, “repeated compression cycles” refers to repeatedly compressing the molded bead foam article with short pauses in between compressions. For example, the original dimension may be subjected to a 20% compression cycle repeated ten times with a two second pause between each cycle. Conventional molded foam articles lose deflection strength after being compressed, and repeated compression cycles further degrades the deflection strength. Conventional EPS-based foam articles lose 30% of their deflection strength after multiple compression cycles, such as the ten cycles of 20% compression each described above, while PLA-based molded bead foam articles without ultra-highly planar particles lose 15% of their deflection strength after multiple compression cycles. It has been unexpectedly discovered that the inclusion of ultra-highly planar particles in PLA-based foam articles significantly reduces the loss of deflection strength after repeated compression cycles.

In some embodiments in which the foam article is a molded bead foam article, after repeated compression cycles of 20% compression, the molded bead foam article experiences a thickness reduction, referred to as “compression set,” of between about 4% to about 10% of its original thickness. Lower compression set is desired in applications such as protective and reusable packaging. Conventional molded foam articles deform after being compressed, and repeated compression cycles further degrades the structural integrity of the foam article, increasing the deformation. Conventional EPS-based foam articles experience compression set between 6-20% of their original thickness after multiple compression cycles corresponding to 10 to 25% compression. PLA-based molded bead foam articles without ultra-highly planar particles experience compression set of 5-16% of their original thickness after multiple compression cycles each having 10 to 25% compression. In some embodiments in which the foam article is a molded bead foam article, the molded bead foam article has a compression set of from about 88% to about 96% when deformed from about 10% to about 25% in a given direction.

In some embodiments in which the foam article is a molded bead foam article, the molded bead foam article with ultra-highly planar particles has a flexural strength of between about 10% and about 25% greater than a molded bead foam article without ultra-highly planar particles. In some embodiments, the molded bead foam article with ultra-highly planar particles has a compression strength after 10% distance compressed of between about 7% and about 25% greater than a molded bead foam article without ultra-highly planar particles. In some embodiments, the molded bead foam article with ultra-highly planar particles has a compression strength after 20% distance compressed of between about 15% and about 45% greater than a molded bead foam article without ultra-highly planar particles. In some embodiments, the molded bead foam article with ultra-highly planar particles has a compression set after 20% deformation of between about 1% and about 3% greater than a molded bead foam article without ultra-highly planar particles. In some embodiments, the molded bead foam article with ultra-highly planar particles has a deflection distance of between about 10% and about 60% greater than a molded bead foam article without ultra-highly planar particles. In some embodiments, the molded bead foam article with ultra-highly planar particles has a flexural modulus of 33-44 psi or greater at a density of 1.2-1.6 pcf.

In some embodiments in which the foam article is a molded bead foam article, the molded bead foam articles with ultra-highly planar particles have an R-Value of between about 2.5% and about 16% greater than a molded bead foam article without ultra-highly planar particles. In some embodiments, the molded bead foam article with ultra-highly planar particles passes the ISTA 7E Heat Test with a time of at least 30 hours. Conventional EPS-based molded articles or PLA-based molded articles without ultra-highly planar particles, having the same dimensions, pass the ISTA 7E Heat Test with a time of only around 24 hours.

In some embodiments in which the foam article is a molded bead foam article, the molded bead foam articles with ultra-highly planar particles have a compression loss at 25% deflection distance of between about 20% and about 45% lower than a molded bead foam article without ultra-highly planar particles.

### Methods of Making Molded Foam Articles

Methods of making molded foam articles are also provided. In some embodiments, the inclusion of ultra-highly planar particles in the PLA foam beads reduces the cycle-time for molding the molded bead foam article by about 70% compared to conventional EPS molding. As used herein, “conventional EPS molding” refers to the formation of molded articles from expandable polystyrene, which is a well-known process that involves injecting foam particles into a mold, followed by injecting the mold with steam, cooling with water, and subjecting the mold to a vacuum. The foam particles expand and fuse together to take on the shape of the mold. The inclusion of ultra-highly planar particles in the PLA foam beads reduces the cycle-time for molding the molded bead foam article by about 70% compared to EPS molding with graphite included, such as the EPS described in U.S. Pat. No. 6,340,713 to BASF SE.

In some embodiments, the inclusion of ultra-highly planar particles in the PLA foam beads reduces the cycle-time for molding the molded bead foam article by about 45% compared to a PLA bead foam molding process that does not include ultra-highly planar particles, such as the PLA molding process described in U.S. Pat. No. 11,213,980 to Lifoam Industries LLC, which is hereby incorporated by reference in its entirety.

In some embodiments, the inclusion of ultra-highly planar particles in the PLA foam beads reduces the cycle-time for molding the molded bead foam article by about 10% compared to the molding process described in U.S. patent application Ser. No. 17/656,700 to Lifoam Industries LLC, which is hereby incorporated by reference in its entirety.

Without intending to be bound by any particular theory, it is believed that the reduction in cycle-time is a result of higher pressure steam during the molding process as compared to molding other PLA foam particles without ultra-highly planar particles, which in turn reduces overall steam time. It is believed that the inclusion of ultra-highly planar particles increases viscosity of the PLA polymer melt prior to formation into foam beads. It is believed that this change in chemical formulation enables the use of higher pressure steam during molding. By including ultra-highly planar particles such as graphite, the molded foam article stabilizes faster and more uniformly. The effect of ultra-highly planar particles on the viscosity of the PLA enables bead foam molding at higher temperatures without collapsing of beads.

In some embodiments, the method for molding the molded bead foam article having ultra-highly planar particles requires a stabilization time between about 15% and about 45% shorter than a method for molding a molded bead foam article without ultra-highly planar particles.

### Examples

The disclosure may be further understood with reference to the following non-limiting examples.

### Example 1: Comparison of Bead Molding Cycle Times

PLA-based molded foam articles, without graphite, were produced following three different molding processes: the process described in U.S. Pat. No. 11,213,980 to Lifoam Industries LLC (A); the process described in U.S. patent application Ser. No. 17/656,700 to Lifoam Industries LLC (B); and the conventional EPS process parameters (C). A PLA-based molded foam article, with Graf+®, available commercially from NeoGraf Solutions, LLC, Lakewood, Ohio, USA, was produced following the process described in U.S. patent application Ser. No. 17/656,700 and was compared to each of processes A, B, and C. The process parameters and cycle times are displayed in Tables 1-3.

TABLE 1
Cycle Time of Molding Articles Having Graphite Compared to Molded
Articles Produced by ′980 Patent Process Without Graphite

| ′980 Patent Process, | | | ′700 Pat. App. Process, | | | | |
|---|---|---|---|---|---|---|---|
| No Graphite | | | with Graphite | | | | |
| | Time | % of | | Time | % of | | |
| Step | (sec) | Total | Step | (sec) | Total | Difference | |
| Steam Before | 3 | 9% | Steam Before | 0 | 0% | −3.0 | sec |
| Fill | 3 | 9% | Steam + Fill | 2.5 | 14% | −0.5 | sec |
| Hydraulics | 6.8 | 21% | Hydraulics | 6.8 | 39% | +0.0 | sec |
| Direct Steam | 1.2 | 4% | Direct Steam | 2.7 | 15% | +1.5 | sec |
| Vent to | 2 | 6% | Vent to | 0.5 | 3% | −1.5 | sec |
| Atmosphere | | | Atmosphere | | | | |
| Stabilization | 15 | 47% | Stabilization | 4 | 23% | −11.0 | sec |
| Cycle Pause | 1 | 3% | Cycle Pause | 1 | 6% | +0.0 | sec |
| Total Time | 32 | | Total Time | 17.5 | | −14.5 | sec |
| Total Steaming | 4.2 | | Total Steaming | 3.7 | | −0.5 | sec |
| Time | | | Time | | | | |
| Max Temp | 98.7 | | Max Temp | 106.0 | | 7.3° | C. |
| (° C.) | | | (° C.) | | | | |
| Min Temp | 81.1 | | Min Temp | 92.0 | | 10.9° | C. |
| (° C.) | | | (° C.) | | | | |
| ΔT (° C.) | 17.6 | | ΔT (° C.) | 14.0 | | −3.6° | C. |

TABLE 2
Cycle Time of Molding Articles Having Graphite Compared to Molded
Articles Produced by ′700 Pat. App. Process Without Graphite

| ′700 Pat. App. Process, | | | ′700 Pat. App. Process, | | | | |
|---|---|---|---|---|---|---|---|
| without Graphite | | | with Graphite | | | | |
| | Time | % of | | Time | % of | | |
| Step | (sec) | Total | Step | (sec) | Total | Difference | |
| Steam Before | 0 | 0% | Steam Before | 0 | 0% | +0.0 | sec |
| Steam + Fill | 2.5 | 14% | Steam + Fill | 2.5 | 14% | +0.0 | sec |
| Hydraulics | 6.8 | 39% | Hydraulics | 6.8 | 39% | +0.0 | sec |
| Direct Steam | 1.2 | 7% | Direct Steam | 2.7 | 15% | +1.5 | sec |
| Vent to | 1.2 | 7% | Vent to | 0.5 | 3% | −0.7 | sec |
| Atmosphere | | | Atmosphere | | | | |
| Stabilization | 7 | 40% | Stabilization | 4 | 23% | −3.0 | sec |
| Cycle Pause | 1 | 6% | Cycle Pause | 1 | 6% | +0.0 | sec |
| Total Time | 19.7 | | Total Time | 17.5 | | −2.2 | sec |
| Total Steaming | 3.7 | | Total Steaming | 3.7 | | +0.0 | sec |
| Time | | | Time | | | | |
| Max Temp | 96.0 | | Max Temp | 106.0 | | 10.0° | C. |
| (° C.) | | | (° C.) | | | | |
| Min Temp | 86.0 | | Min Temp | 92.0 | | 6.0° | C. |
| (° C.) | | | (° C.) | | | | |
| ΔT (° C.) | 10.0 | | ΔT (° C.) | 14.0 | | 4.0° | C. |

TABLE 3
Cycle Time of Molding Articles Having Graphite
Compared to Molded Articles Produced by Conventional
EPS Process Without Graphite

| Conventional EPS Process | | | ′700 Pat. App. Process, | | | | |
|---|---|---|---|---|---|---|---|
| without Graphite | | | with Graphite | | | | |
| | Time | % of | | Time | % of | | |
| Step | (sec) | Total | Step | (sec) | Total | Difference | |
| Steam | 0 | 0% | Steam | 0 | 0% | +0.0 | sec |
| Before | | | Before | | | | |
| Fill | 7 | 11% | Steam + Fill | 2.5 | 14% | −4.5 | sec |
| Hydraulics | 10 | 16% | Hydraulics | 6.8 | 39% | −3.2 | sec |
| Direct Steam | 13 | 21% | Direct Steam | 2.7 | 15% | −10.3 | sec |
| Cooling | 3 | 5% | Vent to | 0.5 | 3% | −2.5 | sec |
| Water + Air | | | Atmosphere | | | | |
| Stabilization | 28 | 45% | Stabilization | 4 | 23% | −24.0 | sec |
| Cycle Pause | 1 | 2% | Cycle Pause | 1 | 6% | +0.0 | sec |
| Total Time | 62 | | Total Time | 17.5 | | −44.5 | sec |
| Total | 10 | | Total | 3.7 | | −6.3 | sec |
| Steaming | | | Steaming | | | | |
| Time | | | Time | | | | |
| Max Temp | 110.1 | | Max Temp | 106.0 | | −4.1° | C. |
| (° C.) | | | (° C.) | | | | |
| Min Temp | 82.1 | | Min Temp | 92.0 | | 9.9° | C. |
| (° C.) | | | (° C.) | | | | |
| ΔT (° C.) | 28.0 | | ΔT (° C.) | 14.0 | | −14.0° | C. |

### Example 2: Comparison of Mechanical Properties for Flat Panels

PLA-based molded foam articles were produced as described herein in the form of flat panels having varying levels of graphite loading. The graphite used was in the form of graphite masterbatch with PLA carrier (GMB) having an average particle size of 20 microns. GMB was added to PLA followed by introduction of supercritical CO2 to produce PLA bead foam. The PLA bead foam was molded using the '700 patent process as described in Example 1.

The flexural strength as measured by ASTM C203, compression strength after 10% distance compressed as measured by ASTM D1621, compression strength after 20% distance compressed as measured by ASTM D3575 (Part D), the compression set after 20% deformation modified from ASTM D3575, the bend as measured by ASTM C203, the deflection distance as measured by ASTM C203, the stabilization time recorded based on '700 patent process, and the shrinkage were measured for each level of graphite loading. The results are displayed in Table 4.

TABLE 4
Comparison of Mechanical Properties for Various Graphite Loads

| | 0% | 0.25% | 0.5% | 0.6% | 0.875% | 1% |
|---|---|---|---|---|---|---|
| | GMB | GMB | GMB | GMB | GMB | GMB |
| Flexural | 30 | 31 | 36 | 37 | 37 | 38 |
| Strength (psi) | | | | | | |
| Compression | 16 | 17 | 19 | 18 | 20 | 20 |
| Strength | | | | | | |
| 10% (psi) | | | | | | |
| Compression | 17 | 21 | 24 | | 24 | 27 |
| Strength | | | | | | |
| 20% (psi) | | | | | | |
| Compression | 95% | 95% | 96% | | 98% | 99% |
| Set (@20%) | | | | | | |
| Bend (e) | 382 | 394 | 411 | 469 | 428 | 435 |
| Deflection | .50 | .51 | .57 | .52 | .59 | .61 |
| Distance (in) | | | | | | |
| Stabilization | 7 | 6 | 5 | 9 | 4 | 3.5 |
| Time (s) | | | | | | |
| Shrinkage | 1.5- | 1- | 0.6- | | 0.3- | 0- |
| | 2% | 1.5% | 0.9% | | 0.6% | 0.3% |

### Example 3: Comparison of Thermal Properties for Flat Panels

The PLA-based molded foam articles in Example 2 were also analyzed for their thermal properties. The R-value of each article was measured and the results are presented in Table 5.

TABLE 5
Comparison of Thermal Properties for Various
Graphite Loads

| | 0% | 0.25% | 0.5% | 0.875% | 1% |
|---|---|---|---|---|---|
| | GMB | GMB | GMB | GMB | GMB |
| R-Value | 4 | 4.1 | 4.15 | 4.28 | 4.32 |

### Example 4: Comparison of Thermal Properties for Thermal Shippers

PLA-based molded foam articles were produced as described herein in the form of 8 inch×6 inch×8 inch thermal shippers. The PLA-based shippers were equipped with an enhanced lip design, as described in U.S. patent application Ser. No. 17/397,582 to Lifoam Industries, LLC. The PLA-based shippers were compared to a conventional EPS-based shipper having a conventional rectilinear lip design. Each shipper was tested according to ISTA 7E Heat Test using a 100 mL water vial. The results of the test are presented in Table 6.

TABLE 6
ISTA 7E Heat Test Results

| | ISTA 7E Heat |
|---|---|
| Shipper | Test Results |
| Conventional EPS | 25.0 hours |
| ePLA with 0% graphite | 27.3 hours |
| ePLA with 0.25% graphite | 32.0 hours |
| ePLA with 0.50% graphite | 33.0 hours |
| ePLA with 0.875% graphite | 33.8 hours |

### Example 5: Comparison of Deflection Distance and Max Compression Loss

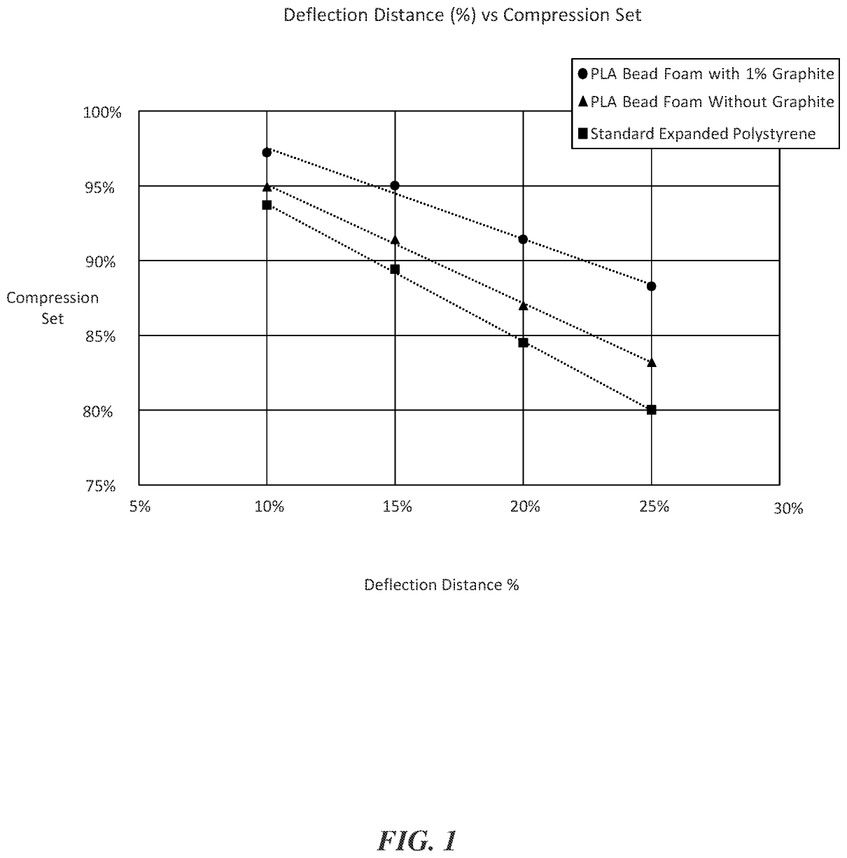

Two PLA-based molded foam articles were produced as described herein, one having 1.0% graphite loading and one without graphite loading. An EPS control was also prepared. The compression set values were measured for deflection ranging from 10% to 25%. The value obtained from the 10% deflection test involved compressing the sample 10 times to 10% compression distance, with each compression cycle punctuated with a 2 second pause. The results are displayed in FIG. 1.

As shown in FIG. 1, the PLA-based molded foam articles with 1.0% graphite loading have the least amount of compression set of the samples analyzed. Standard PLA-based bead foam outperformed the EPS, but the inclusion of ultra-planar particles contributed to an even greater increase in performance over conventional EPS.

### Example 6: Molded Part Mechanical Variability

Three different graphite particles were combined with PLA at 0.6 wt % loading and 0.45 wt % talc. The mean particle size of the three types of graphite particles was 10 microns (GMB-A), 20 microns (GMB-B) and 75 microns (GMB-C). The GMB-A and GMB-B were partially expanded grades while GMB-C was higher density expandable grade. Table 7 lists the standard deviation in density, flexural strength, elasticity, and deflection distance for the samples and a PLA sample without GMB.

TABLE 7
Standard Deviation in Mechanical Properties for
Different Graphite Particle Sizes

| | | Flexural | | Deflection |
|---|---|---|---|---|
| | Density | Strength | Elasticity | Distance |
| | standard | standard | standard | standard |
| | deviation | deviation | deviation | deviation |
| | (lb/cuft) | (psi) | (e) | (in) |
| PLA | 0.07 | 2.0 | 40 | 0.07 |
| with no | | | | |
| GMB | | | | |
| GMB-A | 0.03 | 1.2 | 26 | 0.02 |
| GMB-B | 0.04 | 0.8 | 31 | 0.03 |
| GMB-C | 0.01 | 1.1 | 23 | 0.04 |

As shown in Table 7, the variability in mechanical properties is reduced with the addition of graphite for density, flexural strength, elasticity and deflection distance at break. Each mechanical property benefits differently depending on the size of the graphite particles.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirt and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure it not to be seen as limited by the foregoing described, but is only limited by the scope of the appended claims.

That which is claimed is:

1. A foam article comprising polylactic acid and a plurality of ultra-highly planar particles.

2. The foam article of claim 1, wherein the article is in the form of (i) a molded bead foam article, (ii) a sheet foam article, (iii) a foam film article, or (iv) an injection molded foam article.

3. The foam article of claim 1, wherein the plurality of ultra-highly planar particles comprise (i) graphite, (ii) mica, (iii) quartz, (iv) high structure carbon, (v) carbon nanotubes, (vi) montmorillonite, (vii) fumed silica, (viii) Wollastonite, (ix) kaolin, (x) planar talc, (xi) precipitated planar calcium carbonate or (xii) a combination thereof.

4. The foam article of claim 1, wherein the plurality of ultra-highly planar particles comprise natural or synthetic graphite.

5. The foam article of claim 1, wherein the plurality of ultra-highly planar particles comprise expandable graphite.

6. The foam article of claim 1, wherein the plurality of ultra-highly planar particles have surface treatment or coating.

7. The foam article of claim 1, wherein the ultra-highly planar particles are present in an amount of between about 0.25% to about 5% by weight.

8. The foam article of claim 1, wherein the ultra-highly planar particles have an average size of between about 1 microns and about 300 microns.

9. The foam article of claim 2, wherein the foam article is a molded bead foam article, and wherein the molded bead foam article loses less than 5% of its deflection strength after repeated compression cycles at 10% compression.

10. The foam article of claim 1, wherein the foam article is a molded bead foam article, the molded bead foam article has a compression set of from about 88% to about 96% when deformed from about 10% to about 25% in a given direction.

11. The foam article of claim 1, wherein the foam article is a molded bead foam article, and wherein the molded bead foam article has a flexural strength of between about 10% and about 25% greater than a molded foam article without ultra-highly planar particles.

12. The foam article of claim 1, wherein the foam article is a molded bead foam article, and wherein the molded bead foam article has a compression strength after 10% distance compressed of between about 7% and about 25% greater than a molded foam article without ultra-highly planar particles.

13. The foam article of claim 1, wherein the foam article is a molded bead foam article, and wherein the molded bead foam article has a compression strength after 20% distance compressed of between about 15% and about 45% greater than a molded foam article without ultra-highly planar particles.

14. The foam article of claim 1, wherein the foam article is a molded bead foam article, and wherein the molded bead foam article has a compression set after 20% deformation of between about 2% and about 5% greater than a molded foam article without ultra-highly planar particles.

15. The foam article of claim 1, wherein the foam article is a molded bead foam article, and wherein the molded bead foam article has a flexural modulus of 33-44 psi or greater at a density of 1.2-1.6 pcf.

16. The foam article of claim 1, wherein the foam article is a molded bead foam article, and wherein the molded bead foam article has a deflection distance of between about 10% and about 60% greater than a molded foam article without ultra-highly planar particles.

17. The foam article of claim 1, wherein the foam article is a molded bead foam article, and wherein the molded bead foam article has an R-Value of between about 2.5% and about 16% greater than a molded foam article without ultra-highly planar particles.

18. The foam article of claim 1, wherein the foam article is a molded bead foam article, and wherein the molded bead foam article passes the ISTA 7E Heat Test with a time of at least 20% longer duration opposite without additive.

19. The foam article of claim 1, wherein the foam article is a molded bead foam article, and wherein the molded bead foam article has a compression strength loss at 25% deflection distance of between about 20% and about 45% lower than a molded foam article without ultra-highly planar particles.

20. A method of making a foam article, comprising:
providing foam particles that comprise (i) a homopolymer, graft polymer, or copolymer of polylactic acid, or blends containing other biopolyesters and (ii) a plurality of ultra-highly planar particles;
introducing the foam particles into a mold;
molding the foam particles to form the molded foam article; and
removing the molded foam article from the mold.

21. The method of claim 20, wherein the method is effective at reducing a cycle time for making the molded foam article by between about 10% to about 70% compared to molding foam particles without ultra-highly planar particles.

22. The method of claim 20, wherein molding the foam particles includes a stabilization time between about 15% and about 45% shorter than a method for molding a molded bead foam article without ultra-highly planar particles.
